(19) United States
(12) Patent Application Publication
(10) Pub. No.: US 2016/0050029 A1
(43) Pub. Date: Feb. 18, 2016

(54) HYBRID DONGLE CABLE ASSEMBLY

(71) Applicant: ADC Telecommunications, Inc., Berwyn, PA (US)

(72) Inventors: Thomas P. Huegerich, Fuquay Varina, NC (US); Wayne M. Kachmar, North Bennington, VT (US); Eric Ryan Chappell, Statesville, NC (US)

(21) Appl. No.: 14/828,186

(22) Filed: Aug. 17, 2015

Related U.S. Application Data
(60) Provisional application No. 62/038,798, filed on Aug. 18, 2014.

(51) Int. Cl. H04B 10/80; H01R 24/64; G02B 6/42

(52) U.S. Cl. CPC H04B 10/808; G02B 6/4293; G02B 6/4285; H01R 24/64

(57) ABSTRACT

The present disclosure is directed to a hybrid dongle cable assembly connectable to a standard copper cable terminated by an RJ-45 jack. The hybrid dongle cable assembly has a cable carrying electrical conductors and optical fibers. The hybrid dongle cable assembly further includes first and second connectors housing a fiber optic transceiver, DC converter, and integrated circuit chip, wherein both of the connectors are connectable to a copper cable.

### CROSS-REFERENCE TO RELATED APPLICATIONS

The present application claims the benefit of U.S. Provisional Patent Application Ser. No. 62/038,798, filed Aug. 18, 2014, which application is hereby incorporated by reference in its entirety.

### TECHNICAL FIELD

The present disclosure relates generally to a hybrid dongle cable assembly connectable to a standard RJ-45 interface.

### BACKGROUND

Machine-to-machine wireless communication continues to grow at a rapid pace, driving the demand for high-speed connectivity to the Internet. However, the rapid growth is countered by slowly growing wireless networks and related infrastructure, creating bandwidth problems for devices seeking to connect to existing wireless networks that are overloaded. Accordingly, copper communication solutions comprising copper cables are employed to connect high-speed devices directly to other devices or to modems, but such copper solutions have length and bandwidth limitations. Alternatively, optical fiber solutions are costly and cumbersome, requiring external optical to electrical converters, several external power sources, and RJ-45 patch cords and adapters.

### SUMMARY

In general terms, this disclosure is directed to a hybrid copper fiber cable having a hardware dongle interface connectable to a standard RJ-45 plug or jack.

In an embodiment, a cable assembly is disclosed, wherein the cable assembly comprises a hybrid cable with a first end and a second end, the cable carrying first and second electrical conductors and first and second optical fibers. The cable assembly further comprises an electrical cable extension having a first end connectorized by an electrical connector and a first conversion module that provides a conversion interface between the hybrid cable and the electrical cable extension. The first conversion module includes: a fiber optic transceiver for converting optical signals from the hybrid cable to electrical signals transmitted to the electrical cable extension and for converting electrical signals from the electrical cable extension to optical signals transmitted to the hybrid cable; a direct current converter for providing power from the hybrid cable to the fiber optic transceiver; and an integrated circuit chip for managing electrical signal allocation.

### BRIEF DESCRIPTION OF THE DRAWINGS

FIG. 1 is a system diagram illustrating a hybrid copper fiber cable connected between two high-speed devices.

FIG. 2 is a block diagram of a connector of the hybrid dongle cable assembly.

FIG. 3 is an exploded view of an alternative embodiment of a hybrid dongle cable assembly having connectors on both ends connectable to a copper cable, terminated by an RJ-45 connector.

FIG. 4 illustrates a hybrid dongle cable assembly having splice boxes for length adjustability.

FIG. 5 illustrates a cross-sectional view of a hybrid copper fiber cable of the hybrid dongle cable assembly.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As set forth above, an increased use of high-speed devices may result in network and bandwidth limitations, which drives the demand for high speed interconnectivity using cable arrangements. As such, embodiments of the present disclosure relate generally to a high speed hybrid dongle cable assembly comprising a high-speed, hybrid copper fiber cable and connectors on each end of the cable. The connectors each house an optical transceiver, thereby enabling connectivity to standard copper cables. Data communication over optical fibers at such distances reduces signal degradation as is typically observed with copper cables.

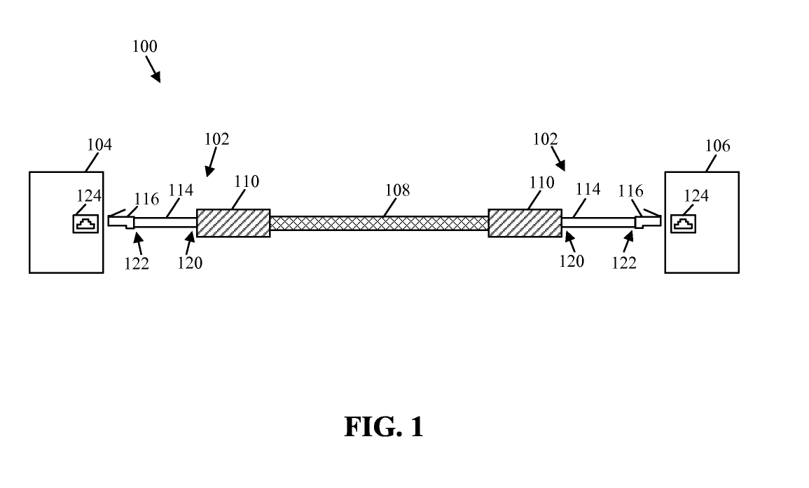

FIG. 1 is a system diagram illustrating a first high-speed device 104 connected to a second high-speed device 106 using a hybrid cable 108, which carries two optical fibers and one or more electrical conductors, and is optically and electrically connected to a hybrid dongle cable assembly 102 on each end of the hybrid cable 108. In this example embodiment, the first and second high-speed devices 104 and 106 may be a computing device such as, for example, a voice over Internet Protocol phone or a mobile or desktop computing device. As illustrated, the first high speed device 104 and second device 106 also include an RJ-45 jack 124 having a plurality of electrical contacts comprising signal contacts and power contacts. In this example, the first high speed device 104 and second device 106 are powered by a wall outlet and include an AC-DC power supply (not shown).

In this example embodiment, the hybrid dongle cable assembly 102 comprises a conversion module 110, an electrical cable extension 114, such as, for example, a copper cable, and an RJ-45 connector 116. As illustrated, the conversion module 110 is electrically connected to the electrical cable extension 114, which is terminated by an RJ-45 connector 116. In this example configuration, the conversion module 110 is directly connected to a first end 120 of the electrical cable extension 114 using a pigtail configuration. Also shown in this example embodiment, the electrical cable extension 114 is terminated, at a second end 122, by an RJ-45 connector 116, which connects to an RJ-45 jack 124 of the first and second high speed devices 104 and 106, respectively. In this example, data is sent over the optical fibers and power and ground are carried over the conductive wire(s) in the hybrid cable 108.

The hybrid dongle cable assembly 102 therefore enables the connectivity of first and second high speed devices 104 and 106 that are positioned at distances greater than the length of a copper cable while using standard RJ-45 connectors.

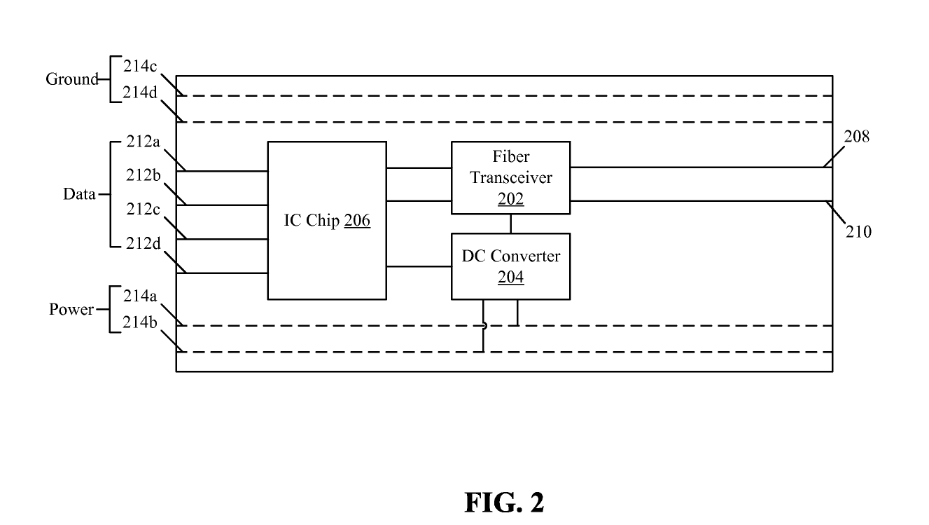

FIG. 2 is a block diagram of a conversion module 110 of the hybrid dongle cable assembly 102. As illustrated, the conversion module 110 includes a fiber optic transceiver 202, a DC converter 204, and an integrated circuit (IC) chip 206. The fiber optic transceiver 202, which is used to convert optical signals to electrical signals and electrical signals to optical signals, is optically connected to the optical fibers 208 and 210. In some embodiments, the fiber optic transceiver 202 is connected to the optical fibers 208 and 210 via an optical pigtail. In particular, the receiver of the fiber optic transceiver 202 converts optical signals received from optical fiber 208 to electrical signals, which are thereafter directed to the IC chip 206. The transmitter of the fiber optic transceiver 202 converts electrical signals to an optical signal using, for example, a laser diode or a light emitting diode. The optical signal is then transmitted through the optical fiber 210 and carried over the hybrid cable 108.

In some embodiments, the IC chip 206 is used to route electrical signals converted by the fiber optic transceiver 202 to various pins, for example, pins 212a-212d, which make electrical contact with the electrical cable extension 114. The IC chip 206 is also used to route electrical signals, received from the electrical cable extension 114 and from any of pins 212a-212d, to the fiber optic transceiver 202. In embodiments, the IC chip 206 manages data transmission and reception to and from the electrical cable extension 114, including signal routing and signal power management.

In this example, the DC converter 204 uses the power received from the electrical conductors 214a and 214b to power the fiber optic transceiver 202 and IC chip 206. As set forth above, the electrical conductors 214a and 214b route power originating from one of the first high speed device 104 and second high speed device 106. In some embodiments, conductors 214c and 214d are used for ground.

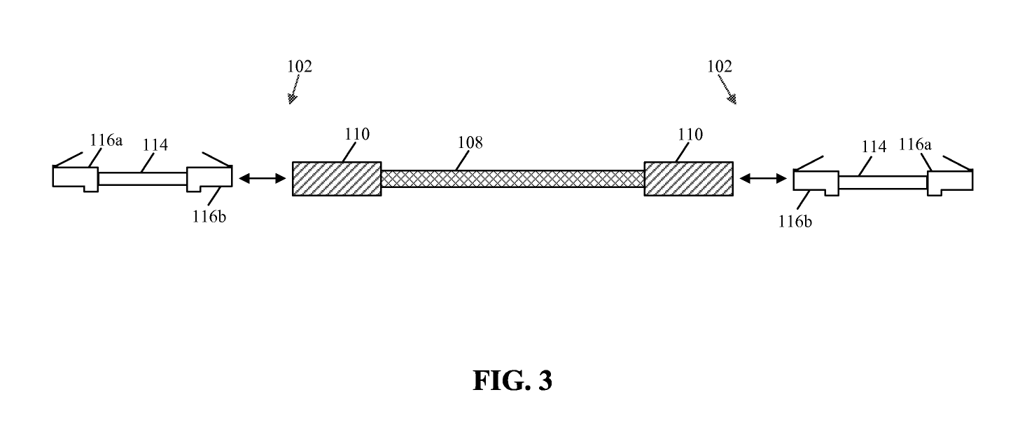

FIG. 3 is an exploded view of an alternative embodiment of a hybrid cable 108 having two ends, each end optically and electrically connected to a hybrid dongle cable assembly 102. As shown, each hybrid dongle cable assembly 102 comprises: a conversion module 110 and an electrical cable extension 114, which is terminated by an RJ-45 connector 116a and 116b on each end of the electrical cable extension 114. As discussed herein, the electrical cable extension 114 may be a copper cable. This example embodiment, wherein the electrical cable extension 114 is terminated on each end by an RJ-45 connector 116a and 116b, is referred to as a jumper configuration. The RJ-45 connector 116b is mounted to one end of the electrical cable extension 114 and is used to easily attach and detach the electrical cable extension 114 to conversion module 110. As illustrated, the RJ-45 connector 116b directly connects to the conversion module 110. Accordingly, the conversion module 110 of this embodiment additionally includes an integrated RJ-45 jack to allow matability with RJ-45 connector 116b.

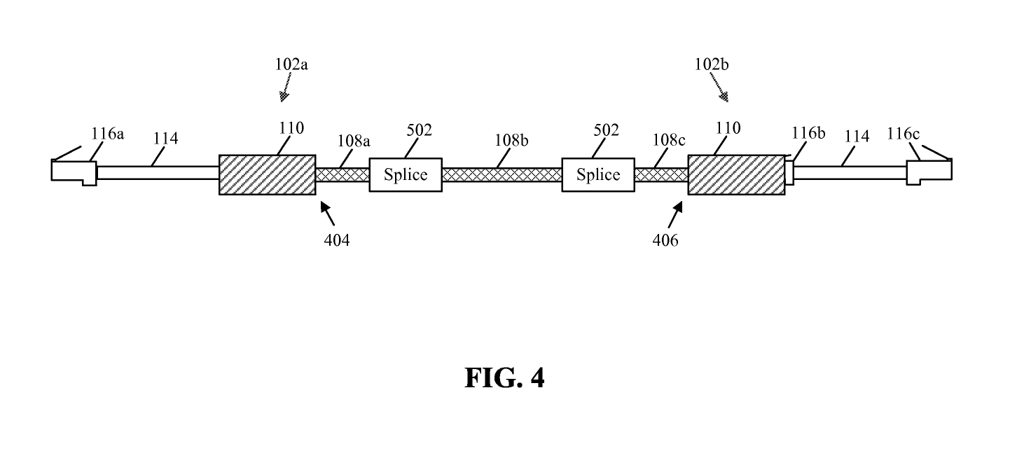

FIG. 4 illustrates a hybrid cable 108 having a first end 404 and a second end 406, wherein the first end 404 is optically and electrically connected to a first hybrid dongle cable assembly 102a, and the second end 406 is optically and electrically connected to a second hybrid dongle cable assembly 102b.

As illustrated, the first hybrid dongle cable assembly 102a is optically and electrically connected to a first end 404 of the hybrid cable 108. The first hybrid dongle cable assembly 102a comprises a conversion module 110 that is electrically connected to an electrical cable extension 114, which is terminated by a first RJ-45 connector 116a. As shown, the electrical cable extension 114 and the conversion module 110 of the first hybrid dongle cable assembly 102a are electrically connected using a pigtail configuration, as described with reference to FIG. 1.

The second hybrid dongle cable assembly 102b is optically and electrically connected to a second end 406 of the hybrid cable 108. The second hybrid dongle cable assembly 102b comprises a conversion module 110 that is electrically connected to an electrical cable extension 114, which is terminated by a second RJ-45 connector 116b and a third RJ-45 connector 116c on each end of the electrical cable extension 114. As shown, the electrical cable extension 114 and the conversion module 110 of the first hybrid dongle cable assembly 102a are electrically connected using a jumper configuration, as described with reference to FIG. 3. This illustration is an example embodiment of a hybrid cable 108 connected to a first and second hybrid dongle cable assembly 102a and 102b, respectively, and any combination of configurations to connect the electrical cable extension 114 to the conversion module 110 may be used.

Also illustrated in this example embodiment are splice boxes 502 used to splice the hybrid cable 108 for length adjustability. The hybrid cable 108 is spliced into three sections 108a-108c, wherein sections 108a and 108c are optically and electrically connected to the conversion module 110 using a pigtail configuration. In some embodiments, the length of section 108b of the hybrid cable 108 can be varied, whereas in other embodiments, the length of sections 108a and 108c can be varied. Accordingly, custom adjustment of the hybrid cable 108 can be accomplished using the splice boxes 502. The splice boxes 502 may include mounting apparatuses such as sheath clamps that hold the optical fibers in place. Once the optical fibers are stripped and cut to a desired length, the splice boxes are used to mechanically align and hold the fibers together so as to allow the passing of light through the optical fibers while minimizing light refraction. The splice boxes 502 also include terminal lugs that connect the conductive wires.

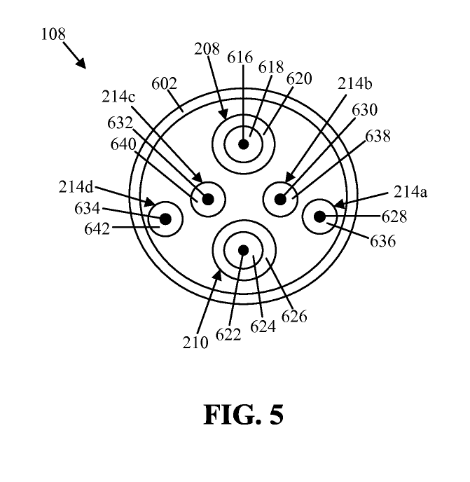

FIG. 5 illustrates a cross-sectional view of a hybrid cable 108, which is optically and electrically connected to the hybrid dongle cable assembly 102. In this embodiment, the hybrid cable 108 is housed in an insulating outer jacket 602 and includes first and second optical fibers 208 and 210, respectively. The hybrid cable 108 also includes four electrical conductors 214a-214d, such as copper conductors, for example.

As shown in this embodiment, the first optical fiber 208 includes a core region 616 that is surrounded by a cladding region 618 and an outer coating region 620. The second optical fiber 210 is substantially similar to the first optical fiber 208 and also has a core region 622 surrounded by a cladding region 624 and an outer coating region 626. In some embodiments, the first and second optical fibers 208 and 210, respectively, are single-mode optical fibers and have the following example dimensions: the core regions 616 and 622 have a diameter in the range of about 8 micrometers to about 10 micrometers, the cladding regions 618 and 624 have a diameter in the range of about 120 micrometers to about 130 micrometers, and the coating regions 620 and 626 of a single-mode optical fiber have a diameter in the range of about 190 micrometers to about 260 micrometers.

In other embodiments, the optical fibers 208 and 210 are multi-mode fibers and have the following example dimensions: the core regions 616 and 622 have a diameter in the range of about 50 micrometers to about 100 micrometers, the cladding regions 618 and 624 have a diameter in the range of about 120 micrometers to about 140 micrometers, and the coating regions 620 and 626 have a diameter in the range of about 235 micrometers to about 260 micrometers.

As shown in this embodiment, the four electrical conductors 214a-214d each include a conductive core 628, 630, 632, and 634; and an insulating layer 636, 638, 640, and 642. In some embodiments, additional insulating layers are used. In some embodiments, the first and second electrical conductors 214a and 214b, respectively, are used to deliver power originating from one of the first high speed device 104 or the second device 106 over the hybrid dongle cable assembly 102 while the third and fourth electrical conductors 214c and 214d, respectively, are used for ground. Common types of conductive materials that are used are copper or aluminum; however, in other embodiments, other types of conductive materials are used. In embodiments, the hybrid dongle cable assembly 102 includes reinforcing structures such as aramid yarn, fiber reinforced polymeric (e.g., epoxy) rods, or other structures.

The various embodiments described above are provided by way of illustration only and should not be construed to limit the overall intention aspects disclosed herein. Those skilled in the art will readily recognize various modifications and changes that may be made without following the example embodiments and applications illustrated and described herein, and without departing from the true spirit and scope of the aspects disclosed herein.

What is claimed is:

1. A cable assembly comprising:
a hybrid cable with a first end and a second end, the cable carrying first and second electrical conductors and first and second optical fibers;
an electrical cable extension having a first end connectorized by an electrical connector;
a first conversion module that provides a conversion interface between the hybrid cable and the electrical cable extension, the first conversion module including: a fiber optic transceiver for converting optical signals from the hybrid cable to electrical signals transmitted to the electrical cable extension and for converting electrical signals from the electrical cable extension to optical signals transmitted to the hybrid cable; a direct current converter for providing power from the hybrid cable to the fiber optic transceiver;
and an integrated circuit chip for managing electrical signal allocation.

2. The cable assembly of claim 1, wherein the electrical cable extension is a pigtail having a second end terminated at the first conversion module.

3. The cable assembly of claim 2, wherein the electrical connector at the first end of the electrical cable extension is an RJ-45 connector.

4. The cable assembly of claim 1, wherein the electrical cable extension is a jumper having a second end connectorized by an electrical connector, and wherein the first conversion module includes an electrical jack for receiving the electrical connector at the second end of the electrical cable extension.

5. The cable assembly of claim 1, wherein the first conversion module includes optical fiber pigtails that are spliced to the first and second optical fibers of the hybrid cable.
